(19) United States
(12) Patent Application Publication
(10) Pub. No.: US 2023/0348320 A1
(43) Pub. Date: Nov. 2, 2023

(54) FOAMED GLASS AGGREGATE LAYER COMPACTION

(71) Applicant: Aero Aggregates of North America, LLC, Eddystone, PA (US)

(72) Inventors: Archibald Stewart Filshill, Huntingdon Valley, PA (US); Theresa A. Loux, Langhorne, PA (US)

(73) Assignee: Aero Aggregates of North America, LLC, Eddystone, PA (US)

(21) Appl. No.: 17/793,307

(22) PCT Filed: Jan. 15, 2021
(86) PCT No.: PCT/US2021/013673

§ 371 Date: Jul. 15, 2022

Related U.S. Application Data
(60) Provisional application No. 62/961,998, filed on Jan. 16, 2020.
(60) Provisional application No. 62/983,129, filed on Feb. 28, 2020.

(51) Int. Cl. C03C 11/00; G01N 21/85; G01N 21/47; G01S 17/89

(52) U.S. Cl. CPC C03C 11/007; G01N 21/85; G01N 21/47; G01S 17/89; G01N 2021/8592; G01N 2021/4735

(57) ABSTRACT

Systems and methods are disclosed for a method of compacting a layer of foamed glass aggregates, comprising, depositing the layer of foamed glass aggregates, compacting the layer of foamed glass aggregates, and determining a compaction level of the layer of foamed glass aggregates using light detection and ranging (LiDAR). Systems and methods are also disclosed for a method of determining a compaction level of a layer of foamed glass aggregates, comprising, depositing the layer of foamed glass aggregates, compacting the layer of foamed glass aggregates, and measuring the compaction level of the layer of foamed glass aggregates using light detection and ranging (LiDAR).

### CROSS REFERENCE TO RELATED APPLICATIONS

This application claims priority to U.S. Provisional Ser. No. 62/961,998 filed Jan. 16, 2020, and U.S. Provisional Ser. No. 62/983,129 filed Feb. 28, 2020, the disclosures of which are incorporated by reference herein in their entireties.

### BACKGROUND

Foam glass aggregates may be used for applications in the ground, such as, for example, fill (e.g., lightweight fill for construction applications, landfill cover, building insulation, coastal resiliency amelioration, etc.). Typically, fill must be compacted (e.g., to avoid settling and other undesirable movement). Fill may be compacted by conventional construction equipment, such as, for example, a bulldozer, excavator, vibratory plate, roller, etc.

However, it is an important goal in the industry to determine when a layer of foamed glass aggregates is sufficiently compact.

Thus, what is needed are improved systems and methods for compacting a layer of foamed glass aggregates and/or determining when the compaction is sufficient.

### SUMMARY

Systems and methods are disclosed for a method of compacting a layer of foamed glass aggregates, comprising, depositing the layer of foamed glass aggregates, compacting the layer of foamed glass aggregates, and determining a compaction level of the layer of foamed glass aggregates using light detection and ranging (LiDAR).

Systems and methods are also disclosed for a method of determining a compaction level of a layer of foamed glass aggregates, comprising, depositing the layer of foamed glass aggregates, compacting the layer of foamed glass aggregates, and measuring the compaction level of the layer of foamed glass aggregates using light detection and ranging (LiDAR).

### BRIEF DESCRIPTION OF THE DRAWINGS

FIG. 1 depicts foam glass aggregates, such as ultra-lightweight foamed glass aggregates (UL-FGA).

FIG. 2 depicts a first analysis area.

FIG. 3 depicts a multipart analysis area.

FIG. 4 depicts multiple lifts, each compacted with multiple passes.

FIG. 5 depicts a plot of volume reduction versus number of compactor passes.

FIG. 6 depicts a plot of volume reduction versus number of compactor passes.

FIG. 7 depicts a plot of volume reduction versus number of compactor passes.

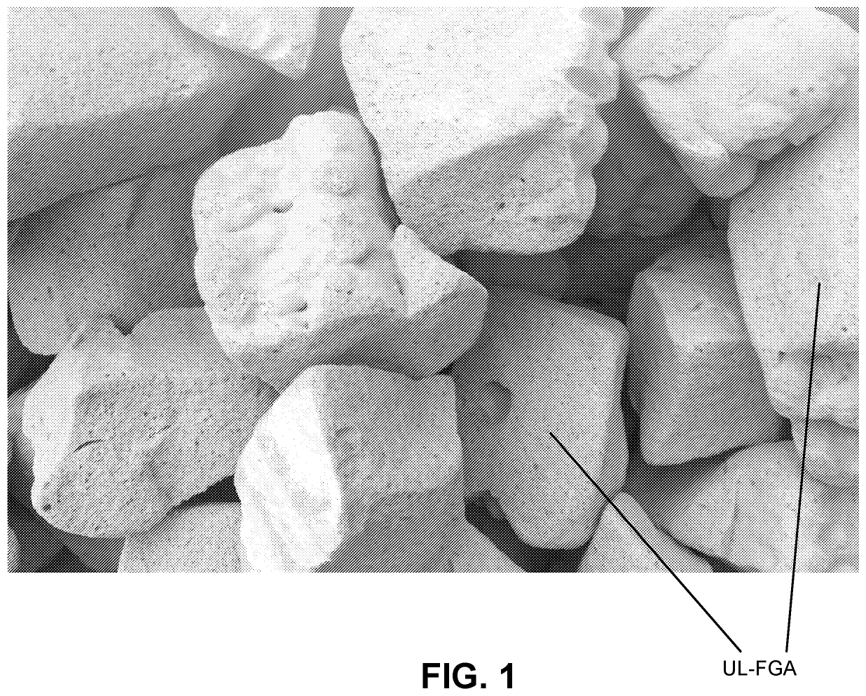

### DETAILED DESCRIPTION

Systems and methods are disclosed for a method of compacting a layer of foamed glass aggregates, comprising, depositing the layer of foamed glass aggregates, compacting the layer of foamed glass aggregates, and determining a compaction level of the layer of foamed glass aggregates using light detection and ranging (LiDAR).

In another example, systems and methods are also disclosed for a method of determining a compaction level of a layer of foamed glass aggregates, comprising, depositing the layer of foamed glass aggregates, compacting the layer of foamed glass aggregates, and measuring the compaction level of the layer of foamed glass aggregates using light detection and ranging (LiDAR).

Light detection and ranging (LiDAR) is a surveying method that measures distance to a target by illuminating the target with laser light and measuring the reflected light with a sensor. Applicants have discovered that, for foam glass aggregates, LiDAR results differ with varying levels of compaction.

Examples of commercially available LiDAR systems include those available under from Topcon, Teledyne Optech, Trimble, Faro, and the like.

A compaction level may be determined using LiDAR.

In one example, the compaction level is measured as a change as compared to a first measurement of the layer of foamed glass aggregates before compacting. Accordingly, the first measurement may be X and subsequent measurements would decrease as percentages of X (as the layer grows more compact). Alternatively, the first measurement could be correlated with a void volume or a volume of foamed glass aggregates and, as the layer grows more compact, subsequent measurements would represent a decrease in void volume or a volume of foamed glass aggregates. Alternatively, the first measurement could be correlated with a void volume, and subsequent measurements would represent volume reduction as percentages as the layer grows more compact. Alternatively, the first measurement may be a first specific gravity-type measurement (such as, for example, a bulk density) and subsequent measurements would be measured as a changing specific gravity-type measurement (e.g., as the layer grows more compact). For example, the specific gravity-type measurement may be a bulk density or a net specific gravity or a bulk specific gravity.

In another example, the compaction level is measured and represented as a number (for example, a natural number). Subsequent compaction levels could be larger (e.g., if representing level of compaction/volume reduction) or smaller (e.g., if representing void space).

As may be appreciated with respect to either of the foregoing examples concerning compaction levels, the voids are greater when less compaction is present. Compaction may follow a curve that shows a significant, early, void (e.g., volume) reduction that levels off.

In an example of using the compaction level, a compacting step may be repeated until a measured compaction level experiences a volume reduction from the first measured compaction level of from about 5% to about 25%, including those numbers and all combinations and ranges therein. In another example of using the compaction level, a compacting step may be repeated until a measured compaction level experiences a change of less than about 1% from the previously measured compaction level.

Foam glass aggregates are an inert (e.g., non-reactive), stable, and environmentally friendly substrate. Typically, to form foam glass aggregates, recycled glass is cleaned, ground, mixed with a foaming agent, heated, and allowed to fragment from temperature shock. The resulting aggregates are cellular, with a relatively low bulk density, but relatively high durability Foam glass aggregates have many uses, for example, as a lightweight fill for construction applications, vehicle arrestor beds, building insulation, etc. However, since foam glass aggregates provide an important economic driver for glass recycling, finding new uses and applications for foam glass aggregates is extremely desirable.

Ultra-lightweight foamed glass aggregates (UL-FGA) are a type of foam glass aggregates. One or more layers of UL-FGA may be placed as loose aggregates and then compacted. UL-FGA particles are quite angular, and as a result, the interaction of the various UL-FGA particles defines voids between the particles. As may be appreciated, the voids are greater when less compaction is present. Compaction may follow a curve that shows an early void (e.g., volume) reduction that levels off.

Suitable UL-FGA may be procured from AERO AGGREGATES OF NORTH AMERICA, Eddystone, PA. The UL-FGA may be prepared from a recycled glass cullet. The UL-FGA may be prepared from a sodo-calic glass. As UL-FGA is made up of silica in the majority, it may be considered a natural material for regulatory purposes. As UL-FGA is made from recycled glass, it may be considered environmentally friendly. Alternatively, UL-FGA may be prepared from waste glass (e.g., byproduct from glass manufacture) or other glass particles, for example, glass that is other than post-consumer recycled glass. UL-FGA properties include low unit weight, low thermal conductivity, high strength to density ratio, non-absorbent, non-toxic, non-leachable, chemically stable, impervious to UV degradation, freeze/thaw stable, and fireproof.

Certain UL-FGA properties are particularly beneficial when used as fill, such as, for example, UL-FGA is highly frictional (e.g., once compacted, UL-FGA is unlikely to shift with time), UL-FGA is non-leaching, UL-FGA is chemically stable (e.g., safe and/or nonreactive), UL-FGA is rot-resistant (in fact, UL-FGA is rot proof), UL-FGA is non-flammable, UL-FGA is durable (e.g., UL-FGA does not degrade when used in this application), and UL-FGA is pest resistant (e.g., resists burrowing animals and insects). Moreover, even after compaction, some the interaction of the various UL-FGA particles defines voids between the particles that have been found to be particularly advantageous for stormwater storage.

In a first example, the UL-FGA may have an open cell structure. Open cell foamed glass is produced by using a different foaming agent than that used for closed cell foamed glass. The foaming agent for open cell reacts faster in the heating process and creates inter-connections between the air bubbles which allow water to be absorbed into the aggregates. The UL-FGA with an open cell structure may, in particular, have pores to support growth of microbes and bacteria (such as, for example, to aid in water quality amelioration).

In a second example, the UL-FGA may have a closed cell structure. It is understood that UL-FGA, as used in this disclosure, comprises both open cell or closed cell structures unless specified as one or the other.

UL-FGA (e.g., either open cell UL-FGA or closed cell UL-FGA) may be combined with water treatment media (such as, for example steel slag, calcium carbonates, organoclays, etc.) that removes phosphates, nitrates, and/or hydrocarbons. The water treatment media may be a coating, dusting, or otherwise applied to a surface of the UL-FGA. In a preferred embodiment, the UL-FGA is a closed cell UL-FGA having organoclay deposited on its surface.

The UL-FGA may have a particle size of about 5 mm to about 80 mm, preferably, about 10 mm to about 60 mm. Upon installation, the UL-FGA may have a dry bulk density of about 120 kg/m³ to about 400 kg/m³, preferably about 170 kg/m³ to about 290 kg/m³, and more preferably about 200 kg/m³ to about 240 kg/m³.

In an example of adding fill, a layer of foamed glass aggregates (such as UL-FGA) is deposited in one or more “lifts,” a layer of material of a defined thickness (with an optionally defined width). Each lift may be about 1 foot to about 4 feet thick, preferably each lift is about 1 foot to about 2 feet thick. Each lift is compacted by construction equipment, such as, for example, by a bulldozer, excavator, vibratory plate, or roller. The lift may be continued to be compacted until reaching a desirable compaction level as determined by LiDAR. After compaction, another lift may be deposited over the compacted lift and the process repeated.

The layer(s) of UL-FGA may be used for all load classes and may be placed with up to 450 side slopes without additional reinforcement, or contained by a retaining wall, bulkhead, storm surge wall, or other structure.

A layer of cover soil may be disposed above the UL-FGA fill. A layer of cover soil is disposed above the UL-FGA. The UL-FGA stabilizes the layer of cover soil. For example, UL-FGA has a residual friction angle greater than about 50 degrees, greater than about 52 degrees, preferably about 54 degrees.

An optional liner may be disposed between the UL-FGA fill and a soft soil layer. The optional liner may be a permeable liner. Suitable permeable liners include geotextiles, wovens, and nonwovens (such as polypropylene or polyester fabrics that have been produced to be permeable). The optional liner may be a semi-permeable liner. Suitable semi-permeable liners include nonwovens such as polypropylene or polyesters that have been produced to be semi-permeable. The optional liner may be an impermeable liner. Suitable impermeable liners include those made from reinforced polyethylene, reinforced polypropylene, thermoplastic olefin, ethylene propylene diene monomer, polyvinyl chloride, isobutylene isoprene, butyl rubber, etc. The optional liner may be, or may incorporate, a bentonite clay liner or other geosynthetic clay liner.

The layer(s) of UL-FGA may be associated with a minimal surcharge to the underlying soils. For example, the layer(s) of UL-FGA may be associated with a minimal surcharge to the underlying soils due to its low unit weight. As compared to gravel, the layer(s) of UL-FGA may be about 80% lighter. For example, an average soil weighs about 120 lbs/cf (or pounds per cubic foot (pcf)), whereas UL-FGA weighs about 20-24 lbs/cf (or pcf).

The UL-FGA fill allows water to pass through the layer(s) of UL-FGA, preventing the cover soil from becoming overly saturated. Other drainage systems, such as drainage tile, rain tanks, R-TANK® systems, HIGHDRO® systems, ECOBLOC® systems, may be implanted in conjunction with the UL-FGA layer. Additionally, the UL-FGA layer possesses considerable insulation properties. As a result, the UL-FGA layer acts to prevent sub-soils from freezing, which is beneficial for promoting water infiltration. Advantageously, the drainage tile, if present, may also remain efficacious year-round (e.g., even in winter).

There are intra-particle voids and inter-particle voids. In terms of soil mechanics, porosity is a measurement of inter-particle voids. For example, inter-particle porosity may be determined by a volume of inter-particle air divided by total volume. UL-FGA voids (e.g., inter-particle voids) in the UL-FGA layer have been found to be particularly advantageous for stormwater storage. Even after compaction, the UL-FGA layer may contain greater than 25%, greater than 30%, greater than 35%, or about 40% inter-particle void space (e.g., porosity). This void space may be independent of, or may not correspond closely to, volume reduction. For example, the specific gravity-type measurement (e.g., such as bulk density) of the UL-FGA particles may change during compaction. Significant void space, which provides additional stormwater storage and promotes water infiltration, may remain after compaction. In an example, UL-FGA may be approved for stormwater storage.

In a first embodiment, a method of compacting a layer of foamed glass aggregates is provided, comprising, depositing the layer of foamed glass aggregates, compacting the layer of foamed glass aggregates, and determining a compaction level of the layer of foamed glass aggregates using light detection and ranging (LiDAR). In some aspects, the layer of foamed glass aggregates is deposited in one or more lifts. In some aspects, each lift is about 1 foot to about 4 feet thick, preferably each lift is about 1 foot to about 2 feet thick. In some aspects, the layer of foamed glass aggregates is compacted by a bulldozer, excavator, vibratory plate, or roller. In some aspects, the compaction level is measured as a change as compared to a first measurement of the layer of foamed glass aggregates before compacting. The compaction level may be a number or a change in a specific gravity-type measurement. The method further comprises repeating the compacting step until a measured compaction level experiences a change of less than 1% from the previously measured compaction level. The compaction level may be measured as a change in specific gravity or a change in one or more of bulk density, net specific gravity, or bulk specific gravity. The foam glass aggregates may have a particle size of about 5 mm to about 80 mm. The foam glass aggregates may have a bulk density of about 120 kg/m³ to about 400 kg/m³ at a first moisture content. The foam glass aggregates may be prepared from a recycled glass cullet.

In a second embodiment, a method of determining a compaction level of a layer of foamed glass aggregates is provided, comprising, depositing the layer of foamed glass aggregates, compacting the layer of foamed glass aggregates, and measuring the compaction level of the layer of foamed glass aggregates using light detection and ranging (LiDAR). In some aspects, the layer of foamed glass aggregates is deposited in one or more lifts. In some aspects, each lift is about 1 foot to about 4 feet thick, preferably each lift is about 1 foot to about 2 feet thick. In some aspects, the layer of foamed glass aggregates is compacted by a bulldozer, excavator, vibratory plate, or roller. In some aspects, the layer of foamed glass aggregates is deposited in one or more lifts. In some aspects, each lift is about 1 foot to about 4 feet thick, preferably each lift is about 1 foot to about 2 feet thick. In some aspects, the layer of foamed glass aggregates is compacted by a bulldozer, excavator, vibratory plate, or roller. In some aspects, the compaction level is measured as a change as compared to a first measurement of the layer of foamed glass aggregates before compacting. The compaction level may be a number or a change in a specific gravity-type measurement. The method further comprises repeating the compacting step until a measured compaction level experiences a change of less than 1% from the previously measured compaction level. The compaction level may be measured as a change in specific gravity or a change in one or more of bulk density, net specific gravity, or bulk specific gravity. The foam glass aggregates may have a particle size of about 5 mm to about 80 mm. The foam glass aggregates may have a bulk density of about 120 kg/m³ to about 400 kg/m³ at a first moisture content. The foam glass aggregates may be prepared from a recycled glass cullet.

### EXAMPLES

### Example 1

Recycled glass cullet is cleaned, ground to less than 150 micrometers (US Standard sieve size No. 100), mixed with a foaming agent (e.g., for open cell UL-FGA, a carbonate foaming agent; for closed cell UL-FGA, a silicon carbide foaming agent) in a blending unit, heated, and allowed to fragment from temperature shock. The resulting UL-FGA is cellular. After sample preparation, the initial moisture content is measured following ASTM D2216 (2010), grain size distributions are determined following ASTM C136/136M (2006) and the initial bulk density is measured following ASTM C127 (2012a) on the UL-FGA. The average moisture content is determined to be 1.06% (initially, the moisture content will be lower (although if exposed to moisture the UL-FGA can hold up to 10% by volume on its surface)) and the average bulk density is determined to be 227.2 kg/m3 (14.2 pcf). Sieve analyses are performed following the dry sieving method on the UL-FGA. Particle size ranges from 10 to 30 mm (0.39 to 1.18 in) but is a very uniformly graded material.

### Example 2

Recycled glass cullet is cleaned, ground, mixed with a foaming agent, heated, and allowed to fragment from temperature shock. The resulting UL-FGA is cellular (foaming creates a thin wall of glass around each gas bubble). By volume, UL-FGA is approximately 92% gas bubbles and 8% glass. The water content (per ASTM D 2216) of UL-FGA will change with time due to the cellular nature of the material as the exterior ruptured pores are filled with water and varies from 2% (when contacting water) to 38% after being completely submerged for several days.

### Example 3

A lift of UL-FGA is deposited and compacted by conventional construction equipment. Separate test areas are created for a bulldozer, an excavator, a vibratory plate, and a roller (e.g., >80 kPa static ground pressure).

A Riegl VZ-400 LIDAR scanner is used to generate point cloud data of each test area. The test areas are scanned prior to placing the UL-FGA, after placement, and after each pass of the applicable compactor. Two scanner positions located at either end of the test area may be used to capture the volume of UL-FGA. Alternatively, a single scanner position from greater than 10-12 feet above the lift may be used.

Any compaction of the ground or UL-FGA below the lift under consideration is treated as volume reduction of the lift (since it is only possible to observe the exposed surface). Settlement plates are fashioned out of steel plate and square tubing to track the settlement of underlying lifts during compaction of the uppermost lift. The position of each settlement plate is tracked using a reflector target attached to the telltale that is easily identified by the LiDAR.

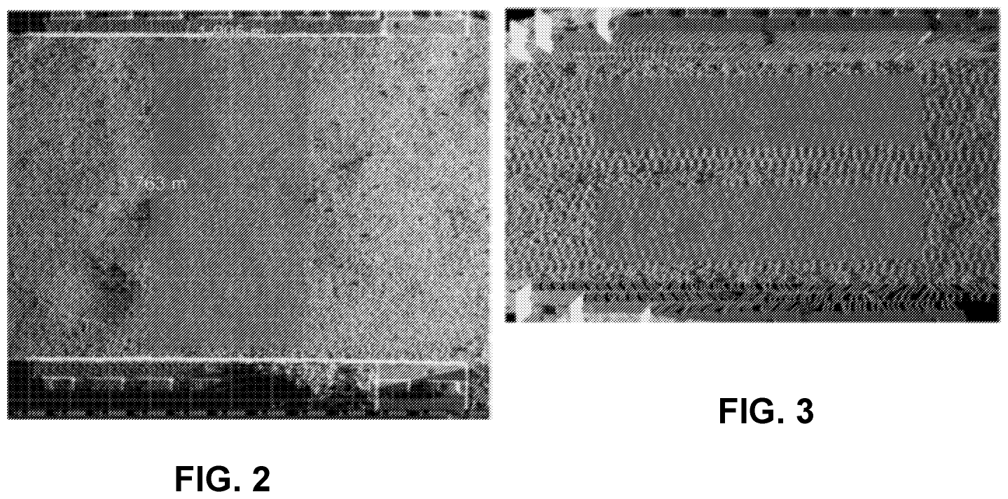

The point cloud data from the experiments is processed to determine the volume of UL-FGA at each stage of compaction. For each test, a plan-view area is delineated for analysis within the test areas. Turning to FIG. 2, the first analysis area is cropped to minimize influences from the test area boundaries. Alternatively, as shown in FIG. 3, two smaller analysis areas are defined within the fill area.

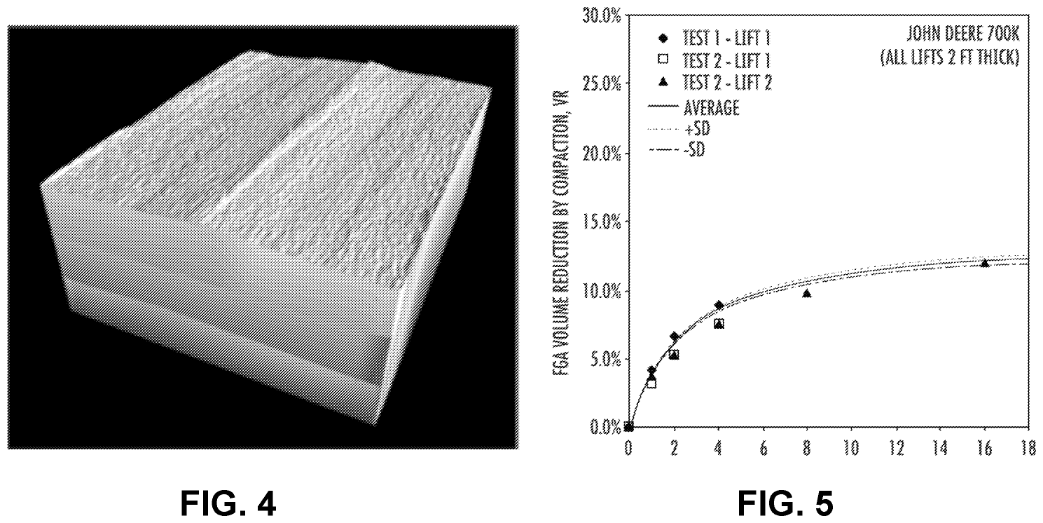

The volume of UL-FGA within the delineated analysis areas is determined using the following: Align the scan data to a common coordinate system, crop the data from all stages of the tests simultaneously to the delineated analysis area; Fit a plane to the cropped point cloud using a least squares algorithm for the condition prior to placement of the first lift of FGA. This planes serves as the datum for volume calculation; Create a triangulated mesh from the filtered point cloud data for each pass. A raster size of 1 centimeter is used for triangulation; Calculate the volume between the reference plane and the triangulated mesh using the automated tool in the Riscan Pro software; and, From the volume, subtract the volume prior to placement of the lift (for the first lift, the subtracted volume is the volume of the ground without FGA above the reference plane). For subsequent lifts (see FIG. 4, which depicts multiple lifts, each compacted in multiple passes), the subtracted volume is the volume of the previous lift of FGA above the reference plane.

The compaction of a lift of FGA after N passes is quantified by defining the percentage of volume reduction,

$$VR = \frac{{V}_{o} - {V}_{N}}{{V}_{o}} \qquad ( 1 )$$

where Vₒ is the uncompacted volume of the lift and V_{N} is the lift volume after N passes. All FGA volumes are obtained from the lidar scanning results with the analysis areas defined for each test.

The volume reduction can be related to the compaction factor, CF which is also sometimes used to quantify compaction,

$$C F = \frac{{V}_{o}}{{V}_{N}} = \frac{1}{1 - VR} \qquad ( 2 )$$

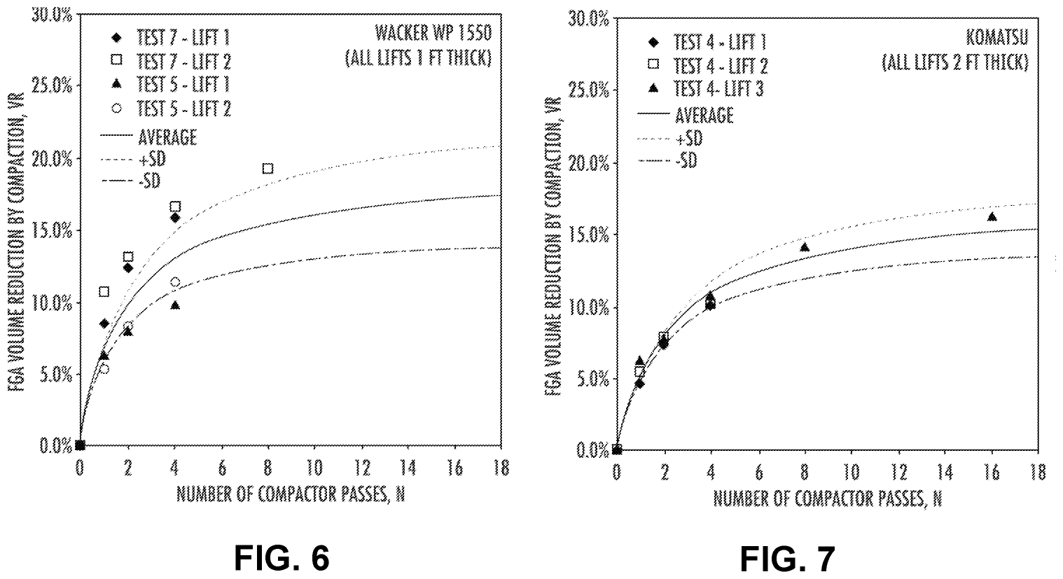

Turning to FIGS. 5-7, plots of volume reduction versus number of compactor passes are shown for different types of compactors. Values of volume reduction include the contribution of additional compaction of underlying lifts. Nearly all of the observed settlement occurred within the first four passes of the equipment.

1. A method of compacting a layer of foamed glass aggregates, comprising,
depositing the layer of foamed glass aggregates,
compacting the layer of foamed glass aggregates, and
determining a compaction level of the layer of foamed glass aggregates using light detection and ranging (LiDAR).

2. The method of claim 1, wherein the layer of foamed glass aggregates is deposited in one or more lifts.

3. The method of claim 2, wherein each lift is about 1 foot to about 4 feet thick.

4. The method of claim 2, wherein each lift is about 1 foot to about 2 feet thick.

5. The method of claim 1, wherein the layer of foamed glass aggregates is compacted by a bulldozer, excavator, vibratory plate, or roller.

6. A method of determining a compaction level of a layer of foamed glass aggregates, comprising,
depositing the layer of foamed glass aggregates,
compacting the layer of foamed glass aggregates, and
measuring the compaction level of the layer of foamed glass aggregates using light detection and ranging (LiDAR).

7. The method of claim 6, wherein the layer of foamed glass aggregates is deposited in one or more lifts.

8. The method of claim 7, wherein each lift is about 1 foot to about 4 feet thick.

9. The method of claim 7, wherein each lift is about 1 foot to about 2 feet thick.

10. The method of claim 6, wherein the layer of foamed glass aggregates is compacted by a bulldozer, excavator, vibratory plate, or roller.

11. The method of claim 6, wherein the compaction level is measured as a change as compared to a first measurement of the layer of foamed glass aggregates before compacting.

12. The method of claim 6, wherein the compaction level is a number.

13. The method of claim 6, further comprising repeating the compacting step until a measured compaction level experiences a change of less than 1% from the previously measured compaction level.

14. The method of claim 6, wherein the compaction level is measured as a change in a specific gravity-type measurement.

15. The method of claim 6, wherein the compaction level is measured as a change in one or more of bulk density, net specific gravity, or bulk specific gravity.

16. The method of claim 6, wherein the foam glass aggregates have a particle size of about 5 mm to about 80 mm.

17. The method of claim 6, wherein the foam glass aggregates have a bulk density of about 120 kg/m³ to about 400 kg/m³ at a first moisture content.

18. The method of claim 6, wherein the foam glass aggregates are prepared from a recycled glass cullet.

19. The method of claim 11, further comprising repeating the compacting step until a measured compaction level experiences a change of less than 1% from the previously measured compaction level.

20. The method of claim 12, further comprising repeating the compacting step until a measured compaction level experiences a change of less than 1% from the previously measured compaction level.
